(19) United States
(12) Patent Application Publication
(10) Pub. No.: US 2018/0099839 A1
(43) Pub. Date: Apr. 12, 2018

(54) ELEVATOR CALL SYSTEM WITH MOBILE DEVICE

(71) Applicant: Otis Elevator Company, Farmington, CT (US)

(72) Inventors: Fred G. Williams, Old Saybrook, CT (US); Paul A. Simcik, Southington, CT (US)

(21) Appl. No.: 15/287,807

(22) Filed: Oct. 7, 2016

(51) Int. Cl. B66B 1/46; G06F 3/0482; H04W 4/04; H04W 4/02

(52) U.S. Cl. CPC B66B 1/468; G06F 3/0482; B66B 2201/4653; H04W 4/021; H04W 4/043

(57) ABSTRACT

A method of operating an elevator call system includes displaying a plurality of elevator destination selections associated with a building on a display screen of a mobile device. For ease of use, the elevator destination selections may be prioritized.

### BACKGROUND

The present disclosure relates to an elevator call system and, more particularly, to an elevator call system utilizing a mobile device.

People generally utilize a multitude of elevators in a multitude of separate buildings. Regardless of what building, the individual must typically first enter the building, locate the elevator, and then select a floor destination while waiting for the elevator car to arrive. Current elevator call systems may utilize mobile devices enabling a user to request a particular floor destination in a particular building, thus reducing the wait time for the elevator car. However, this feature is limited when applied to multiple buildings with multiple floors.

### SUMMARY

A method of operating an elevator call system according to one, non-limiting, embodiment of the present disclosure includes displaying a first plurality of elevator destination selections associated with a first building on a display screen of a mobile device, wherein the first plurality of elevator destination selections is prioritized.

Additionally to the foregoing embodiment, the plurality of elevator destination selections are a plurality of elevator destination combination selections.

In the alternative or additionally thereto, in the foregoing embodiment, the prioritization of the first plurality of elevator destination selections is based at least on frequency of use.

In the alternative or additionally thereto, in the foregoing embodiment, the prioritization of the first plurality of elevator destination selections is based at least on time.

In the alternative or additionally thereto, in the foregoing embodiment, the first plurality of elevator destination selections include a first selection based on time and a second selection based on frequency of use.

In the alternative or additionally thereto, in the foregoing embodiment, each one of the first plurality of elevator destination selections depict a boarding description and a departure description.

In the alternative or additionally thereto, in the foregoing embodiment, the boarding and departure descriptions are associated with different floors of the first building.

In the alternative or additionally thereto, in the foregoing embodiment, the boarding description is automatically known via positioning circuitry of the mobile device.

In the alternative or additionally thereto, in the foregoing embodiment the method includes displaying a second plurality of elevator destination selections associated with a second building on the display screen of the mobile device.

In the alternative or additionally thereto, in the foregoing embodiment, the second plurality of elevator destination selections are prioritized.

In the alternative or additionally thereto, in the foregoing embodiment, the first and second buildings are associated with respective first and second building selections that are prioritized.

In the alternative or additionally thereto, in the foregoing embodiment, prioritization of the first and second building selections is based on geographic proximity enabled by positioning circuitry of the mobile device.

In the alternative or additionally thereto, in the foregoing embodiment, the mobile device is a smartphone.

A method of operating an elevator call system according to another, non-limiting, embodiment includes depicting a first interactive grid display on a display screen of a mobile device, wherein the first interactive grid display depicts a plurality of harbor selections associated with a first building and a my-buildings selection; selecting the my-buildings view selection; and depicting an interactive my-buildings display on the display screen, wherein the interactive my-building display depicts the first building associated with at least one elevator destination selection, and a second building associated with at least one second elevator destination selection.

Additionally to the foregoing embodiment, the first and second elevator destination selections are each a prioritized plurality of elevator destination selections.

In the alternative or additionally thereto, in the foregoing embodiment the method includes selecting an interactive grid view selection of the interactive my-buildings display to depict one of the first interactive grid display and a second interactive grid display, wherein the second interactive grid display depicts a plurality of harbor selections associated with the second building.

In the alternative or additionally thereto, in the foregoing embodiment, the first and second buildings depicted on the interactive my-buildings display are respective first and second building selections.

In the alternative or additionally thereto, in the foregoing embodiment the method includes selecting one of the first and second building selections from the my-buildings display; and depicting the respective one of the first and second interactive grid displays.

In the alternative or additionally thereto, in the foregoing embodiment, the first and second building selections are prioritized.

In the alternative or additionally thereto, in the foregoing embodiment, prioritization of the first and second building selections is based on geographic proximity enabled by positioning circuitry of the mobile device.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of an elevator call system as one, non-limiting, exemplary embodiment of the present disclosure applied to a plurality of buildings;

FIG. 2 is a front view of a mobile device depicting a grid display of the elevator call system; and

FIG. 3 is a front view of the mobile device depicting a my-building display of the elevator call system.

### DETAILED DESCRIPTION

A detailed description of one or more embodiments of the disclosed apparatus and method are presented herein by way of exemplification and not limitation with reference to the Figures.

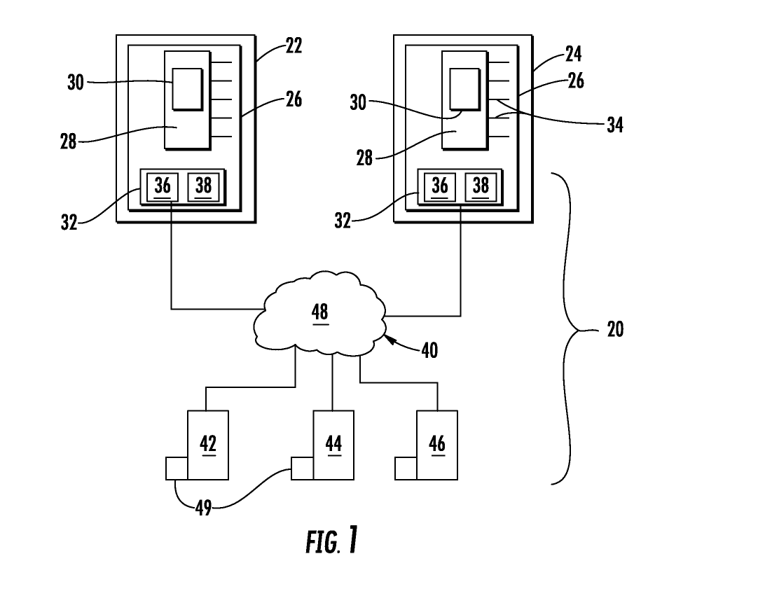

Referring to FIG. 1, an exemplary embodiment of an elevator call system 20 is illustrated and applied to multiple buildings (i.e., two illustrated as 22, 24) each having at least one elevator system 26. Each elevator system 26 may include a hoistway 28, at least one elevator car 30, and a controller 32. The hoistway 28 has boundaries generally defined by the respective building 22, 24. The elevator cars 30 are adapted to travel in the hoistway 28 to deliver passengers to any one of a plurality of destinations 34 that may be, for example, building floors, a building tenant location, and others. The controller 32 is configured to dispatch and control travel of the elevator cars 30 within the hoistway 28, and may function as a server for external communication with, for example, the elevator call system 20.

The controller 32 may include control circuitry such as a computer processor 36, a computer readable and writeable storage medium 38, and input/output (I/O) devices (not shown). The storage medium 38 may include hard disk drive storage, nonvolatile memory (e.g., flash memory or other electrically-programmable-read-only memory configured to form a solid state drive), volatile memory (e.g., static or dynamic random-access-memory), and others. The processor 36 may be based on one or more microprocessors, microcontrollers, digital signal processors, baseband processors, power management units, audio codec chips, application specific integrated circuits, and others. It is further contemplated and understood that the controller 32 may be part of, or may communicate with, a building management system (not shown) configured to control other features incorporated into the building 22, 24 such as security, fire protection, air conditioning, lighting, and others.

The elevator call system 20 may generally include a service provider 40, a multitude of mobile devices (i.e., three illustrated as 42, 44, 46), and a computer program product 48 (e.g., software). The service provider 40 may be configured to communicate between the controllers 32 and the mobile devices 42, 44, 46. The buildings 22, 24 may generally be representative of the most frequently visited buildings of any user of the mobile devices 42, 44, 46. In some embodiments, the buildings may include all buildings visited by the user of the mobile device and arranged in order from most frequently visited to least frequently visited. In one embodiment, the buildings may be arranged in order alphabetically. In one embodiment, the buildings may be arranged in order based upon proximity to the location of the user of the mobile device. More specifically, one group of buildings 22, 24 may be associated with mobile device 42, and another group of buildings may be associated with the mobile device 44 depending upon the building most frequently visited by the respective users. The mobile devices 42, 44, 46 may be any device carried on a person. One example of a mobile device may be a smartphone.

The service provider 40 may generally provide a means of registering the computer program product 48 with a specific building 22, 24 and/or a specific mobile device 42, 44, 46 (i.e. and/or profile of a user thereof), and may further control the information or data that may be visually presented on the mobile devices. The service provider 40 may further provide a consistency across platforms or across buildings 22, 24, such that a user of a mobile device (e.g., mobile device 42) that visits any number of buildings may be presented with a common interface when doing so. In addition, the service provider 40 may be configured to capture user preferences based on user activity (e.g., frequency of visits) as well as user input via the mobile device. The service provider 40 may be cloud-based, and may include one or more computing devices, such as one or more servers. The computer program product 48 may be generally stored and executed within the service provider 40, or may be generally distributed and executed in one or more of the service provider 40, the mobile devices 42, 44, 46, and the controllers 32.

In one embodiment, the users associated with the respective mobile devices 42, 44, 46 may register the mobile device with the service provider 40 (e.g., an application driven service) associated with a specific building 22, 24. The registration information may include information related to the user's home, office, telephone number, favorite places, and others. Facilitated by the computer program product 48, the user may choose to update the service information manually, or in some aspects, the updating may occur automatically. For example, the user may choose to have the service update information based on usage data. Such usage data may include frequently visited floors 34 within, for example, building 22, or frequently visited buildings 22, 24 associated with the elevator call system 20.

In some embodiments, and facilitated by the computer program product 48, the building (e.g., building 22) may register with the service provider 40. The registration information associated with the building 22 may include a tenant directory, floor numbers, office numbers, telephone number associated with each tenant, web sites linked with each tenant, and other information.

Communication between the mobile devices 42, 44, 46 and the buildings 22, 24 may be direct (i.e., without use of the service provider 40) or indirect. Communications may be conducted, in-part, over hard wired connections, and/or may be wireless through a distributed computer network, the cloud, wireless communication networks, and others. In one embodiment, the mobile devices 42, 44, 46 and the controllers 32 may communicate with one-another via Wi-fi, Bluetooth, cellular, zigbee, zwave, and other technologies. Cellular communication applications may travel from the mobile devices, to a cell tower, to a server that may be a cloud server, to another cell tower, and then to the elevator controller. In another embodiment and when proximate to one-another (i.e., within a threshold distance), the mobile devices 42, 44, 46 may communicate with the controllers 32 using near field communications (NFC). Alternatively, the controller 32 may establish communication with the mobile device 42 when the device is immediately outside of, and/or inside, the building 22. It is contemplated and understood that communications may be conducted in any variety of ways with any variety of configurations.

In other embodiments, the mobile devices 42, 44, 46 may each include positioning circuitry 49 configured to establish distances between the mobile device and registered buildings 22, 24, and thereby control communication between the mobile device and the buildings 22, 24 based on respective threshold distances. When beyond, or outside of, the threshold distance to any one building, the user of the mobile device may be capable of performing certain functions relative to the elevator call system 20, however, communication with the controller 32 of a specific building (e.g., building 22) that is beyond the threshold distance may be prohibited. Examples of technologies associated with the positioning circuitry 49 may generally include Global Positioning Systems (GPS), Global Navigation System (GLONASS), Global Navigation Satellite System (GNSS), Galileo, Long Range Navigation (LORAN), National Marine Electronics Association (NMEA), Trimble Standard Interface Protocol (TSIP), DELORME® EARTHMATE®, Rockwell PLGR Protocol, iBeacon®, SIRF®, triangulation, and signal strength detection. It will also be appreciated that positioning circuitry 49 may also be associated with local, regional, or site-wide systems of a type well known in the art, such as radio frequency identification (RFID), infrared (IR), sensor networks, Wi-Fi-based positioning, and Ultra-Wideband (UWB) positioning systems, to name a few non-limiting examples. The positioning circuitry 49 may include a receiver circuit, or circuitry associated with other satellite navigation systems. In any case, the positioning circuitry 49 works to determine the position of the mobile device 42 relative to the buildings 22, 24. It will also be appreciated that the positioning information may include types well known in the arts such as, geographic latitude and longitude, Universal Transverse Mercator (UTM) and Universal Polar Stereographic (UPS) coordinates, stereographic coordinates, geodetic height, Cartesian coordinates, and street address, to name a few non-limiting examples. Such technologies that facilitate early communication may provide the user and the elevator system 26 with more time to establish the most efficient passenger flow, while eliminating or reducing passenger/user wait time for the elevator car 30 to arrive.

In one embodiment, the controllers 32 of each building 22, 24 registered with the service provider 40 may include at least one Bluetooth® device that sends short-range beacon signals that may be received by any of the registered mobile devices 42, 44, 46. When the beacon signal is received by the mobile devices, the mobile device, the service provider 40 and/or the controller 32 may determine the location of the mobile device(s) relative to the building.

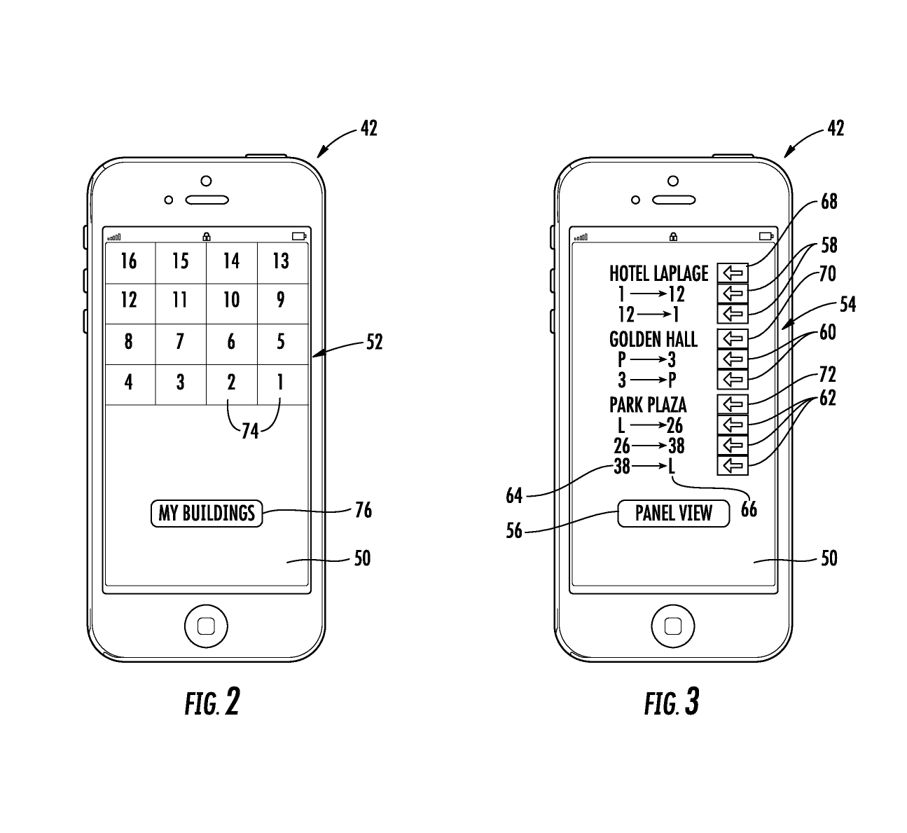

Referring to FIGS. 2 and 3, and for ease of explanation, the mobile device 42 shall be further described with the understanding that the mobile devices 44, 46 may generally be the same. The mobile devices 42 may include a display screen 50 that may be an interactive touch screen. Facilitated by the computer program product 48, the display screen 50 may be configured to depict an interactive grid display 52 (see FIG. 2), and a my-buildings display 54 (see FIG. 3). Both displays 52, 54 may generally be interactive having a multitude of selections that a user of the mobile device 42 may select. In one embodiment, the my-buildings display 54 may include a grid view selection 56, a multitude of elevator destination selections 58, 60, 62, and a plurality of building selections (i.e., three illustrated as 68, 70, 72).

The building selections 68, 70, 72 may be associated with respective buildings 22, 24 and a third building (not shown in FIG. 1), which may all be registered with the service provider 40. Each elevator destination selection 58, 60, 62 may be associated with a respective building selection 68, 70, 72. Each elevator destination selection 58, 60, 62 may be an elevator destination combination selection that includes a boarding description 64 representative of where the user may enter the elevator car 30 and a departure description 66 representative of where the user may exit the elevator car. In one embodiment, it may be presumed that the user may always enter an elevator car 30 from, for example, a lobby, therefore the elevator destination selections 58, 60, 62 may not include a departure description and may only include a destination description. In one embodiment , the computer program product 48 may automatically determine the floor on which the user of the mobile device may be boarding the elevator car. Such a determination may be accomplished via the positioning circuitry 49 of each mobile device 42, 44, 46.

In one embodiment, the building selections 68, 70, 72 may generally be provided as a listing that may be prioritized. For example and as illustrated, building selection 68 may be located at the top of the list indicative of a high priority, and building selection 72 may be displayed at the bottom of the list indicating a lower priority. In one example, building selection 68, as the highest priority, may be associated with the building the user last visited (e.g., building 22). The second from highest priority, building selection 70, may be listed immediately down from building selection 68, and may be representative of the building (e.g., building 24) with a high frequency of user visits over a prescribed time period (i.e., frequency of usage).

Similar to the building selections 68, 70, 72, the elevator destination selections 58, 60, 62 may be provided as a prioritized listing. In one embodiment prioritization may be based on the most recent elevator destination used for a particular building with the most recent elevator destination selection listed first, and so on. In another embodiment, the prioritization may be based on frequency of usage. In one example, the highest prioritized elevator destination selection may be listed at the top, or forefront, of a listing with a prioritization based on time (i.e., the last selection made), and the second highest prioritized elevator destination selection of the same listing may be based on the highest frequency of use. Other combinations and/or factors made also be utilized to formulate and prioritize a plurality of elevator destination selections.

In one embodiment, the selections 58, 60, 62, 68, 70, 72 may be respective, designated areas of the display screen 50 that are interactive (e.g., represented as virtual button). Next to each virtual button may be a description field that specifies what each button represents (see FIG. 3). The description fields may change as, for example, priorities change. In another embodiment, the description fields may generally be part of the virtual selections or buttons, whereby touching the description of each selection will prompt the necessary action.

In one embodiment, if the user does not see a desirable elevator destination selection 58, 60, 62 listed under a particular building selection 68, 70, 72, the user may select the grid view selection 56. By making this selection, the building selections 68, 70, 72 may become interactive for a prescribed period of time. The user may then select the desired building selection 68, 70, 72 and the display screen 50 may convert to the grid display 52 (see FIG. 2) associated with the selected building. It is further contemplated and understood that the my-buildings display 54 may not include a grid view selection 56, and instead, the building selections 68, 70, 72 may be continuously interactive.

Grid display 52 may include a multitude of offered harbor selections 74 for a particular building selection 68, 70, 72, and a my-buildings view selection 76. Each harbor selection 74 may, for example, be associated with a respective floor 34 of a particular building having a plurality of floors. From the multitude of harbor selection 74 the user may then choose a desired destination or harbor by selecting the appropriate harbor selection 74.

Advantages and benefits of the present disclosure includes a mobile device with a customized and prioritized display associated with any number of buildings and a plurality of destinations associated with each building. Other benefits include the reduction in time for a user to make an elevator call selection, and the simplified process of making elevator calls with regards to multiple buildings and multiple destinations within each building.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of operating an elevator call system comprising:
displaying a first plurality of elevator destination selections associated with a first building on a display screen of a mobile device, wherein the first plurality of elevator destination selections is prioritized.

2. The method set forth in claim 1, wherein the plurality of elevator destination selections are a plurality of elevator destination combination selections.

3. The method set forth in claim 1, wherein the prioritization of the first plurality of elevator destination selections is based at least on frequency of use.

4. The method set forth in claim 1, wherein the prioritization of the first plurality of elevator destination selections is based at least on time.

5. The method set forth in claim 3, wherein the first plurality of elevator destination selections include a first selection based on time and a second selection based on frequency of use.

6. The method set forth in claim 1, wherein each one of the first plurality of elevator destination selections depict a boarding description and a departure description.

7. The method set forth in claim 6, wherein the boarding and departure descriptions are associated with different floors of the first building.

8. The method set forth in claim 7, wherein the boarding description is automatically known via positioning circuitry of the mobile device.

9. The method set forth in claim 1 further comprising:
displaying a second plurality of elevator destination selections associated with a second building on the display screen of the mobile device.

10. The method set forth in claim 9, wherein the second plurality of elevator destination selections are prioritized.

11. The method set forth in claim 10, wherein the first and second buildings are associated with respective first and second building selections that are prioritized.

12. The method set forth in claim 11, wherein prioritization of the first and second building selections is based on geographic proximity enabled by positioning circuitry of the mobile device.

13. The method set forth in claim 1, wherein the mobile device is a smartphone.

14. A method of operating an elevator call system comprising:
depicting a first interactive grid display on a display screen of a mobile device, wherein the first interactive grid display depicts a plurality of harbor selections associated with a first building and a my-buildings selection;
selecting the my-buildings view selection; and
depicting an interactive my-buildings display on the display screen, wherein the interactive my-building display depicts the first building associated with at least one elevator destination selection, and a second building associated with at least one second elevator destination selection.

15. The method set forth in claim 14, wherein the first and second elevator destination selections are each a prioritized plurality of elevator destination selections.

16. The method set forth in claim 14 further comprising:
selecting an interactive grid view selection of the interactive my-buildings display to depict one of the first interactive grid display and a second interactive grid display, wherein the second interactive grid display depicts a plurality of harbor selections associated with the second building.

17. The method set forth in claim 16, wherein the first and second buildings depicted on the interactive my-buildings display are respective first and second building selections.

18. The method set forth in claim 17 further comprising:
selecting one of the first and second building selections from the my-buildings display; and
depicting the respective one of the first and second interactive grid displays.

19. The method set forth in claim 17, wherein the first and second building selections are prioritized.

20. The method set forth in claim 19, wherein prioritization of the first and second building selections is based on geographic proximity enabled by positioning circuitry of the mobile device.
